(19) United States
(12) Patent Application Publication
(10) Pub. No.: US 2023/0306713 A1
(43) Pub. Date: Sep. 28, 2023

(54) PICKUP SUPPORT DEVICE, PICKUP SUPPORT METHOD, AND PROGRAM RECORDING MEDIUM

(71) Applicant: NEC Corporation, Minato-ku, Tokyo (JP)

(72) Inventors: Shunsuke Tsuda, Tokyo (JP); Hajime Hagimori, Tokyo (JP)

(73) Assignee: NEC Corporation, Minato-ku, Tokyo (JP)

(21) Appl. No.: 18/021,659

(22) PCT Filed: Sep. 28, 2020
(86) PCT No.: PCT/JP2020/036625

§ 371 Date: Feb. 16, 2023

(51) Int. Cl. G06V 10/74; H04N 7/18; G06V 20/50; B65G 47/90

(52) U.S. Cl. CPC G06V 10/761; H04N 7/183; G06V 20/50; B65G 47/905; G06T 2207/10012

(57) ABSTRACT

A pickup support device according to an aspect of the present disclosure includes: at least one memory configured to store instructions, and at least one processor configured to execute the instructions to: determine whether an object is a pickup target, based on information regarding appearance of the pickup target and information regarding appearance of the object at a position indicated in a pickup request, and output a determination result.

### TECHNICAL FIELD

The present disclosure relates to a pickup support device and the like.

### BACKGROUND ART

In order to efficiently deliver a package, a service has been provided in which a worker of a pickup and delivery company (hereinbelow, simply referred to as a worker) places the package at a placement location designated by a recipient. Also, considered is the provision of a service in which a pickup requester places a package requested to be picked up at a pickup location designated by the requester, such as in front of a front door, and a worker picks up the package. In such a pickup service, it is necessary to identify a pickup target package at a pickup location.

For example, PTL 1 discloses an aerial vehicle that detects a sign for identifying a pickup target package in an image of a pickup area, acquires a pickup position of the package based on the position of the sign, and flies to the pickup position. In PTL 1, the sign is a code indicating identification information of a package, and is attached to a package to be picked up or a case for storing the package.

As a related technique, PTL 2 discloses a technique for presenting a position of a pickup target article in an article collection site such as an article warehouse.

### CITATION LIST

### Patent Literature

[PTL 1] JP 2019-006356 A
[PTL 2] JP 5247854 B2

### SUMMARY OF INVENTION

### Technical Problem

In the case of using the aerial vehicle according to PTL 1, the pickup requester needs to prepare a case to which a sign is attached or to attach the sign to the package. That is, the pickup requester needs to attach information identifying the pickup target package to the package. Here, the information identifying the package is an identification number, a code (including a barcode and a two-dimensional code), or the like for identifying the package, such as the aforementioned sign, printed on the package or a pickup slip or the like attached to the package. In general, a pickup target package is identified by such information identifying the package.

An object of the present disclosure is to solve the aforementioned problems and to provide a pickup support device that is capable of identifying a pickup target at a location indicated in a pickup request even in a case where information identifying the package is not attached to the package.

### Solution to Problem

A pickup support device according to the present disclosure includes a determination means configured to determine whether an object is a pickup target, based on information regarding appearance of the pickup target and information regarding appearance of the object at a position indicated in a pickup request, and an output means configured to output a determination result.

A pickup support method according to the present disclosure includes determining whether an object is a pickup target, based on information regarding appearance of the pickup target and information regarding appearance of the object at a position indicated in a pickup request, and outputting a determination result.

A program recording medium according to the present disclosure non-transiently records a program that causes a computer to execute determination processing of determining whether an object is a pickup target, based on information regarding appearance of the pickup target and information regarding appearance of the object at a position indicated in a pickup request, and output processing of outputting a determination result.

### Advantageous Effects of Invention

According to the present disclosure, it is possible to identify a pickup target at a location indicated in a pickup request even in a case where information identifying the package is not attached to the package.

### BRIEF DESCRIPTION OF DRAWINGS

FIG. 1 is a block diagram illustrating a configuration of a pickup support system 1 according to a first example embodiment.

FIG. 2 is a block diagram illustrating a configuration of a pickup support device 100.

FIG. 3 is a flowchart illustrating processing of the pickup support device 100.

FIG. 4 is a sequence diagram illustrating an operation example of the pickup support system 1.

FIG. 5 is a diagram illustrating an example of a pickup request screen.

FIG. 6 is a diagram illustrating an example of a confirmation screen.

FIG. 7 is a block diagram illustrating a configuration of the pickup support system 1 according to a modification example.

FIG. 8 is a block diagram illustrating an example of a hardware configuration of a computer 500.

### EXAMPLE EMBODIMENT

### First Example Embodiment

In a first example embodiment, a case where a pickup and delivery company instructs a worker to pick up a package based on a pickup request from a pickup requester, and the worker picks up the package placed at a pickup position will be described. The placement location at the pickup position can appropriately be selected by the pickup requester, such as beside a front door, in a post box, in a package receiving box, and in a locker. The worker may receive the package from a person at the pickup position. The package may be stereoscopic or flat. The picked up package is collected at, for example, a package collection site, and then delivered to a delivery location indicated in the pickup request.

### (Configuration)

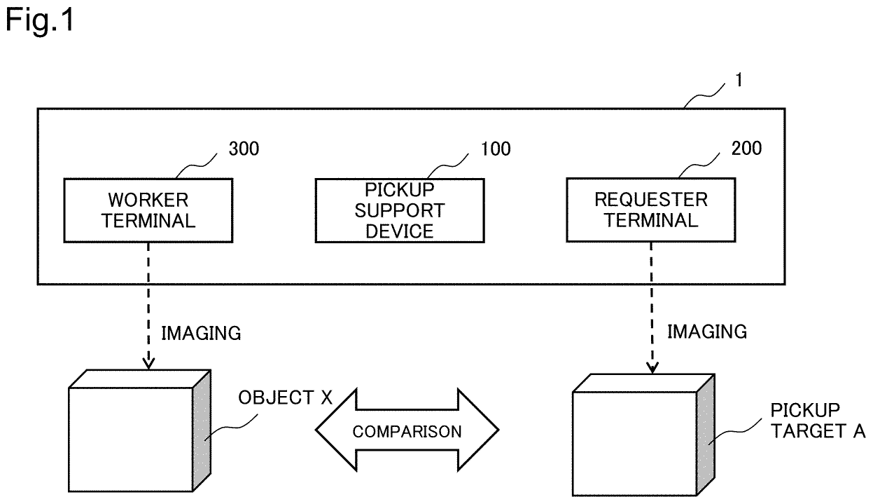

FIG. 1 is a block diagram illustrating a configuration of a pickup support system 1 according to the first example embodiment. The pickup support system 1 includes a pickup support device 100, a requester terminal 200, and a worker terminal 300.

The pickup support device 100 is a server or the like used by a pickup and delivery company. In the first example embodiment, the pickup support device 100 receives information regarding appearance of a pickup target A indicated in a pickup request from the requester terminal 200. Further, in the first example embodiment, the pickup support device 100 receives information regarding appearance of an object X placed at a pickup position from the worker terminal 300. The information regarding the appearance includes, for example, the imaging data obtained by imaging a target (the pickup target A or the object X), the size of the target, and the stereoscopic shape (three-dimensional shape) of the target. The information regarding the appearance may also include information regarding the color or pattern of the target or the type of the packaging material. The information regarding the type of the packaging material is, for example, information indicating whether the target is contained in a cardboard box or in a paper bag or a plastic bag, or wrapped with a cushioning material. The received imaging data may be a still image or a moving image.

The requester terminal 200 is a mobile phone, a tablet, a personal computer, or the like used by a user who requests pickup. The requester terminal 200 receives a pickup request input from the user. The requester terminal 200 includes a camera that images the pickup target A. In a case where the requester terminal does not include a camera, the requester terminal 200 may receive imaging data of the pickup target A from a not-illustrated external device. The requester terminal 200 transmits the imaging data of the pickup target A to the pickup support device 100. Also, the requester terminal 200 generates a pickup request including a pickup position and transmits the pickup request to the pickup support device 100.

The pickup request generated by the requester terminal 200 may include the placement location of the pickup target A at the pickup position such as beside a front door, in a post box, and in a package receiving box as well as the address of the pickup position. The pickup request may further include the pickup time zone that the requester wishes for, the weight of the pickup target A, information identifying the pickup requester, or the like.

The worker terminal 300 is a mobile phone, a tablet, a wearable device, or the like used by a worker who picks up the pickup target A. The worker terminal 300 includes a camera that images the object X placed at the pickup position. The worker terminal 300 may receive imaging data of the object X from a not-illustrated external device. The worker terminal 300 transmits the imaging data of the object X to the pickup support device 100. Further, the worker terminal 300 may receive a determination result from the pickup support device 100 and display the determination result on a not-illustrated display.

In various modification examples, in a case where no imaging data is used, the requester terminal 200 and the worker terminal 300 do not need to include the cameras. In this case, the requester terminal 200 and the worker terminal 300 do not need to receive imaging data from the external device.

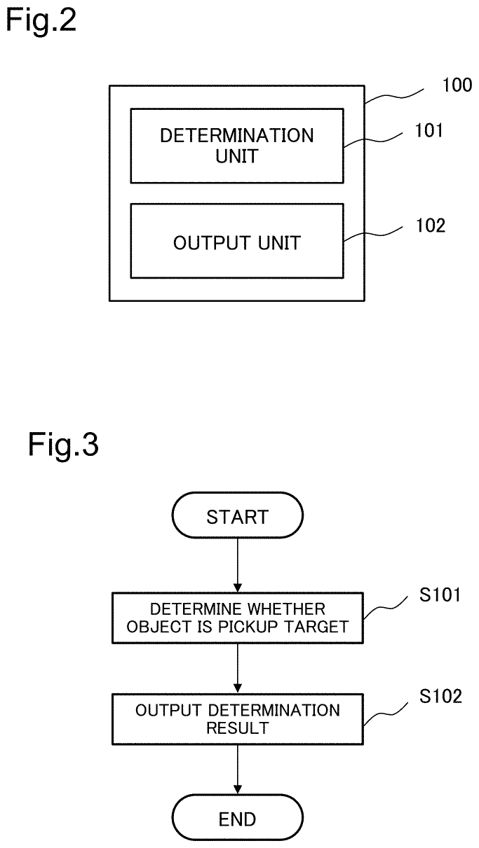

FIG. 2 is a block diagram illustrating a configuration of the pickup support device 100. The pickup support device 100 includes a determination unit 101 and an output unit 102.

The determination unit 101 determines whether an object is a pickup target, based on information regarding appearance of the pickup target and information regarding appearance of the object at a position indicated in a pickup request.

The output unit 102 outputs a result determined by the determination unit 101. The determination result includes determination that the object at the position indicated in the pickup request is the pickup target or determination that the object is not the pickup target. In the first example embodiment, the output unit 102 outputs the determination result to, for example, the worker terminal 300.

Hereinbelow, a determination method by means of the determination unit 101 will be described.

### (Determination Based on Imaging Data)

The determination unit 101 may determine whether the object is the pickup target using imaging data obtained by imaging the target as information regarding appearance of the target.

In this case, for example, the requester places the pickup target A at a freely-selected location, and images the pickup target A from one or more directions using the requester terminal 200 to acquire imaging data. For example, the requester may image the pickup target A having a stereoscopic shape from equal to or more than two directions in such a way that the appearance can be recognized when the pickup target is seen from six directions of the front surface, the back surface, the right and left side surfaces, the top surface, and the bottom surface in a case where a certain direction toward the pickup target is set as the front surface. Imaging of some surfaces such as the bottom surface may appropriately be omitted.

The worker images the object X placed at the pickup position from one or more directions using the worker terminal 300 to acquire imaging data. The worker may image the object X from equal to or more than two directions in a similar manner to that of the requester.

For example, the determination unit 101 determines whether imaging data of the pickup target A from one direction matches any of a plurality of pieces of imaging data of the object X from a plurality of directions. Alternatively, the determination unit 101 may determine whether imaging data of the object X from one direction matches any of a plurality of pieces of imaging data of the pickup target A from a plurality of directions. Here, the determination unit 101 may use, for example, a known image similarity calculation technique to calculate a degree of similarity by comparing the imaging data of the object X with the imaging data of the pickup target A, and determine that the imaging data pieces match each other in a case where the degree of similarity is equal to or more than a threshold value. In this case, the determination unit 101 calculates the degree of similarity by using, for example, the color or pattern of each region in the imaging data and the shape of the target included in the imaging data as feature values.

Also, the determination unit 101 may use, for example, a known pattern matching technique to calculate a degree of similarity by comparing the image of the object X with the image of the pickup target A extracted from the imaging data, and determine that the imaging data pieces match each other in a case where the degree of similarity is equal to or more than a threshold value.

Then, for example, in a case where the imaging data of the object X and the imaging data of the pickup target A match in equal to or more than a predetermined number of sets each including the imaging data of the pickup target A and the imaging data of the object X, the determination unit 101 determines that the object X is the pickup target A.

Note that the imaging data imaged at the time of pickup may include images of a plurality of objects X. In this case, for example, the determination unit 101 may extract each of the images of the plurality of objects X and compare each of the images with the image of the pickup target A. Then, for example, the determination unit 101 determines that the object X having a higher degree of similarity than those of the other objects X among the plurality of objects X is the pickup target A.

Also, the pickup target A indicated in the pickup request may be imaged by the requester terminal 200 in a state where the pickup target A is placed at the pickup position, and imaging data including the background of the pickup target A may be acquired. Similarly, imaging data including the background of the object X may be acquired by the worker terminal 300. In this case, the determination unit 101 may compare the imaging data of the pickup target A including the background with the imaging data of the object X including the background. This can prevent an object placed at a different location from that indicated in the pickup request from being picked up.

### (Determination Based on Size)

The determination unit 101 may further determine whether the object X is the pickup target A based on the size of the pickup target A and the size of the object X at the pickup position. With this method, the determination unit 101 can identify a target having a similar shape and a different size.

In this case, the determination unit 101 may further include a not-illustrated measurement unit that measures the sizes of the targets (the pickup target A and the object X) from the imaging data. Some or all of the functions of the measurement unit may be provided in the requester terminal 200 and the worker terminal 300. In this case, the determination unit 101 receives the measured sizes of the targets from the requester terminal 200 and the worker terminal 300.

For example, the measurement unit recognizes the shape of the target from the imaging data imaged from one direction using an existing image recognition technique. Subsequently, the measurement unit measures the size of the target. For example, the measurement unit measures the height and the width of the target when the object is viewed from one direction. The measurement unit may measure the length of each side of the shape of the recognized target, the length from one side to another side, the length from the center of gravity of the shape to a certain point of the contour, or the like.

Also, the measurement unit may measure the size of the target using, for example, the parallax between two pieces of imaging data imaged from substantially the same directions. Further, the measurement unit may measure the size of the target based on the size of a reference object, imaged together with the object, whose size is known.

The measurement unit may predict the stereoscopic shape of the target in the depth direction from the imaging data from one direction, and measure the depth, as the size of the target, as well as the height and the width of the target.

Also, the measurement unit may recognize the shape of the target based on the distance information instead of the imaging data, and measure the size of the target. The distance information represents a distance between the target and the sensor. In this case, the distance information is acquired by an infrared sensor or the like provided in the requester terminal 200 and the worker terminal 300 and transmitted to the measurement unit. In a case where the distance information is used, the imaging data does not need to be used for measuring the size.

The measurement unit may further measure the size of the target viewed from another direction in a similar method.

The determination unit 101 may further include a not-illustrated comparison unit that compares the size of the pickup target A viewed from one or more directions with the size of the object X viewed from one or more directions. When the difference between the sizes of the pickup target A and the object X is within a predetermined error range, the comparison unit determines that the sizes of the pickup target A and the object X match.

Then, for example, in a case where the imaging data of the object X and the imaging data of the pickup target A match, and where the size of the object X and the size of the pickup target A match, the determination unit 101 determines that the object X is the pickup target A.

The comparison unit may check whether the size of the pickup target A from a certain direction matches any of the sizes of the object X from a plurality of directions. In this case, the determination unit 101 may determine that the object X is the pickup target A in a case where the measured sizes match each other in equal to or more than two directions.

### (Determination Based on Three-Dimensional Shape)

The determination unit 101 may determine that the object X is the pickup target A based on the stereoscopic data of the pickup target A indicated in the pickup request and the stereoscopic data of the object X at the pickup position.

The stereoscopic data represents, for example, the position of the surface of the target in a predetermined three-dimensional coordinate space. The stereoscopic data may represent not only the three-dimensional shape of the target but also the size of the target. Since the three-dimensional shapes of the targets can be compared by the comparison between the stereoscopic data pieces, the determination unit 101 can make a determination even in a case where the pickup target is one having a different shape depending on the viewing direction.

The determination unit 101 may include a not-illustrated stereoscopic data generation unit that generates the stereoscopic data. The determination unit 101 compares the generated stereoscopic data of the object X with the stereoscopic data of the pickup target A. The resolution of the stereoscopic data may be so high as to be capable of measuring a rough entire shape. The function of the stereoscopic data generation unit may be provided in the requester terminal 200 and the worker terminal 300. In this case, the determination unit 101 receives the stereoscopic data pieces from the requester terminal 200 and the worker terminal 300.

For example, the stereoscopic data generation unit may generate the stereoscopic data using the imaging data obtained by imaging the target from a plurality of directions received from the requester terminal 200 or the worker terminal 300. The stereoscopic data generation unit may estimate the stereoscopic shape of the target from one or more still images to generate the stereoscopic data.

Also, the stereoscopic data generation unit may generate the stereoscopic data based on the 3D scan data of the target obtained using infrared rays or laser beams provided in the requester terminal 200 or the worker terminal 300. In a case where the pickup support device 100 does not use the imaging data for generating the stereoscopic data, the pickup support device does not need to receive the imaging data from the requester terminal 200 and the worker terminal 300.

The determination unit 101 may include a not-illustrated comparison unit that compares the three-dimensional shapes of the targets with each other. The comparison unit uses a known stereoscopic (three-dimensional) shape similarity calculation technique to calculate a degree of similarity by comparing the stereoscopic data of the object X with the stereoscopic data of the pickup target A, and determine that the three-dimensional data pieces match each other in a case where the degree of similarity is equal to or more than a threshold value.

Then, in a case where the three-dimensional shape of the object X and the three-dimensional shape of the pickup target A match, the determination unit 101 determines that the object X is the pickup target A.

### (Comparison Based on Image of Target Held in Hand)

The pickup target A or the object X at the pickup position may be imaged in a state of being held in the hand by the pickup requester or the worker. At this time, the determination unit 101 may make a comparison in terms of the imaging data, the size of the target, and the stereoscopic shape of the target by excluding the hand included in the imaging data or the stereoscopic data based on the color, shape, position, and the like of the hand.

### (Operation)

FIG. 3 is a flowchart illustrating processing of the pickup support device 100. The determination unit 101 determines whether an object is a pickup target, based on information regarding appearance of the pickup target and information regarding appearance of the object at a position indicated in a pickup request (step S101). The output unit 102 outputs a determination result (step S102).

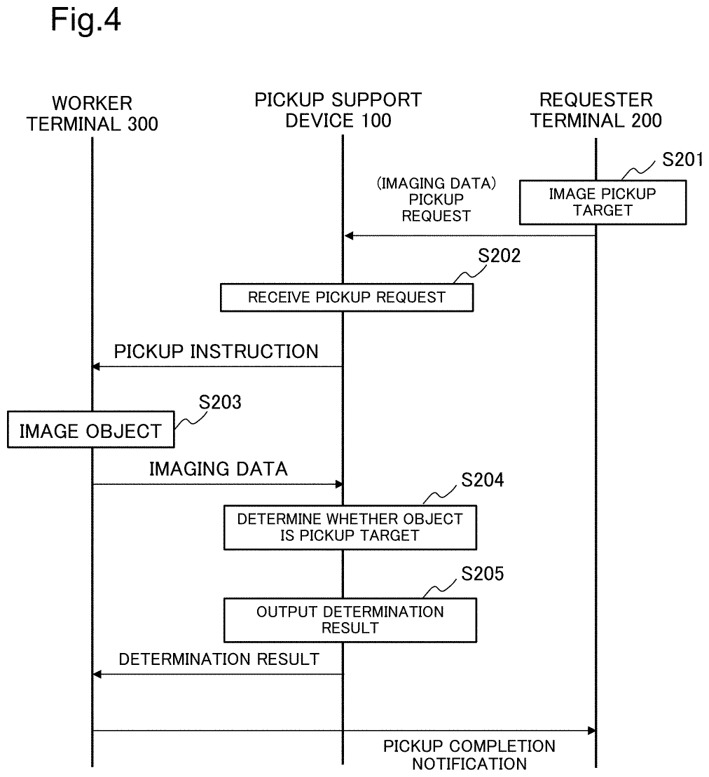

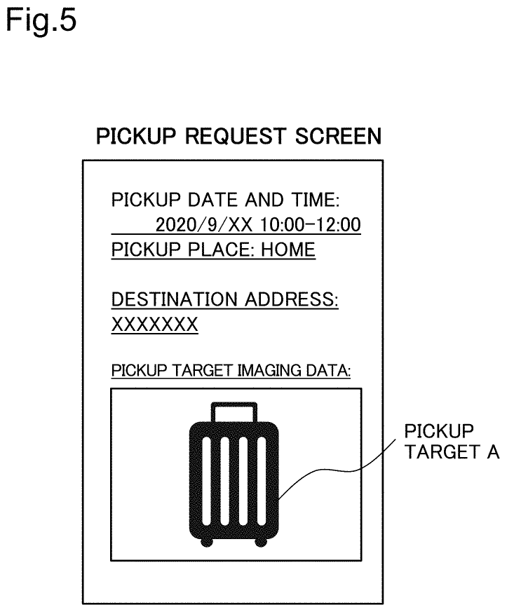

FIG. 4 is a sequence diagram illustrating an operation example of the pickup support system 1. In FIG. 4, a case where imaging data of a target is used will be described. First, the requester terminal 200 images a pickup target that a pickup requester has (step S201). Subsequently, the requester terminal 200 transmits a pickup request including the imaging data of the pickup target and the information identifying the pickup position to the pickup support device 100. FIG. 5 is a diagram illustrating an example of a pickup request screen displayed on the requester terminal 200 when an input of information for the pickup request is prompted. For example, the requester inputs the pickup date and time, the pickup position, the destination address of the package, and the imaging data of the pickup target A on the pickup request screen.

When receiving the pickup request (step S202), the pickup support device 100 transmits a pickup instruction to the worker terminal 300. The pickup instruction includes the pickup date and time and the pickup position. The pickup instruction may further include the imaging data of the pickup target A indicated in the pickup request. The worker, who has seen the delivery instruction, heads to the pickup position indicated in the pickup instruction on the pickup date and time. The worker searches for the pickup target with reference to the imaging data of the pickup target A indicated in the pickup request. The worker terminal 300 images the object X that the worker has found at the pickup position (step S203), and transmits the imaging data to the pickup support device 100.

The determination unit 101 of the pickup support device 100 determines whether the imaged object X is the pickup target A based on the received imaging data of the target (step S204). Subsequently, the output unit 102 of the pickup support device outputs a determination result (step S205), and transmits the determination result to the worker terminal 300.

The worker checks the determination result displayed on the display of the worker terminal 300, and in a case where the imaged object is the pickup target, the worker picks up the object. The worker terminal 300 transmits a pickup completion notification to the requester terminal 200 via the pickup support device 100. The pickup support device 100 may transmit a pickup completion notification including the imaging data used to identify the pickup target to the requester terminal 200.

### (Effects)

According to the first example embodiment, it is possible to identify a pickup target at a location indicated in a pickup request even in a case where information identifying the package is not attached to the package. The reason for this is that the determination unit 101 determines whether an object is a pickup target, based on information regarding appearance of the pickup target and information regarding appearance of the object at a position indicated in a pickup request.

Note that, in the present disclosure, after the pickup target is identified by the pickup support device 100, the worker may attach information for identifying the package to the pickup target. For example, when the pickup target is identified, a not-illustrated printing unit of the worker terminal 300 may print a pickup slip based on the pickup request. The pickup slip includes, for example, a pickup and delivery request, an identification number for identifying the package, and a destination address of the package included in the pickup request, which are provided by the pickup support device 100 or the like. The worker attaches the printed pickup slip to the pickup target.

### Second Example Embodiment

In the second example embodiment, processing of the pickup support system 1 in a case where the pickup target cannot be identified will be described. Regarding the configuration of the second example embodiment, description of similar components to those of the first example embodiment will be omitted.

(Case where there is No Candidate for Pickup Target)

In a case where there is no object at the pickup position, the worker terminal 300 cannot transmit the aforementioned information regarding the appearance of the object X to the pickup support device 100. In this case, the worker terminal 300 may transmit an image obtained by imaging the pickup position and positional information for the current location to the pickup support device 100. The determination unit 101 compares the received image of the pickup position and the positional information with the image and the positional information indicated in the pickup request, and determines that there is no pickup target A at the pickup position.

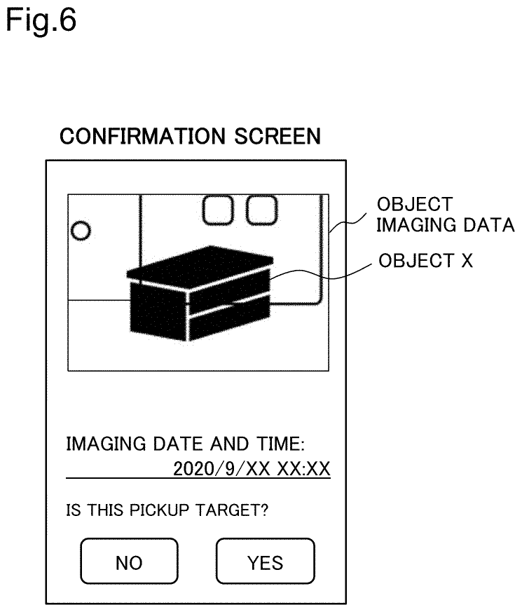

Also, in a case where the calculated degree of similarity is less than the threshold value as a result of the comparison between the object X and the pickup target A indicated in the pickup request, the determination unit 101 cannot identify the pickup target A. In a case where the pickup target cannot be identified based on the information regarding the appearance of the target, the pickup support device 100 may transmit the imaging data of the object X placed at the pickup position to the requester terminal 200 and request the pickup requester for confirmation. FIG. 6 is a diagram illustrating an example of a confirmation screen displayed on the display of the requester terminal 200. In a case where “Yes” is selected in FIG. 6, the determination unit 101 determines that the object X is the pickup target A. In a case where “No” is selected in FIG. 6, the determination unit 101 determines that the object X is not the pickup target. In a case where the pickup support device 100 outputs the result of determining that the object X is not the pickup target, the worker terminal 300 may transmit information regarding appearance of another object X to the pickup support device 100. Alternatively, the worker terminal 300 may perform the aforementioned operation for a case where there is no object at the pickup position.

In this manner, in a case where there is no candidate for the pickup target A, such as a case where there is no object at the pickup position and a case where it cannot be determined that the object X is the pickup target A, the worker terminal 300 may transmit abort of pickup to the pickup support device 100. The pickup support device 100 may transmit a pickup abort notification including the image obtained by imaging the pickup position to the requester terminal 200.

(Case where there are a Plurality of Candidates for Pickup Target)

In a case where a plurality of objects X each of whose imaging data matches the pickup target A are detected as a result of the comparison between the object X at the pickup position and the pickup target A, the determination unit 101 cannot identify the pickup target. At this time, the pickup support device 100 sets the plurality of detected objects X as candidates for the pickup target and transmits the imaging data including the plurality of candidates to the requester terminal 200. The requester terminal 200 displays the imaging data and prompts the pickup requester to select the pickup target A. The determination unit 101 determines that the selected object X is the pickup target A. The pickup support device 100 notifies the worker terminal 300 of the object X selected in the determination result, and the worker picks up the selected pickup target A.

In a case where there is no selection by the pickup requester, the pickup support device 100 may, for example, transmit an instruction to abort pickup to the worker terminal 300.

### (Effects)

According to the second example embodiment, even in a case where the pickup support device 100 cannot identify the pickup target A based on the information regarding the appearance of the target, the pickup target can be identified. The reason for this is that the pickup support device 100 transmits the imaging data of the object X to the pickup requester, and the determination unit 101 determines that the object X is the pickup target A based on the input by the pickup requester.

### [Modification Example] Pickup By Robot

In each of the above-described example embodiments, pickup of a package may be performed by a robot. That is, in the above description, the action of the worker may be replaced with the operation executed by the robot. The pickup robot includes an unmanned ground vehicle and an unmanned aerial vehicle (drone). In the present modification example, the worker terminal 300 is replaced with the robot. Also, the pickup support device 100 may be built in the robot or may be provided in a server of a pickup and delivery company that manages the robot.

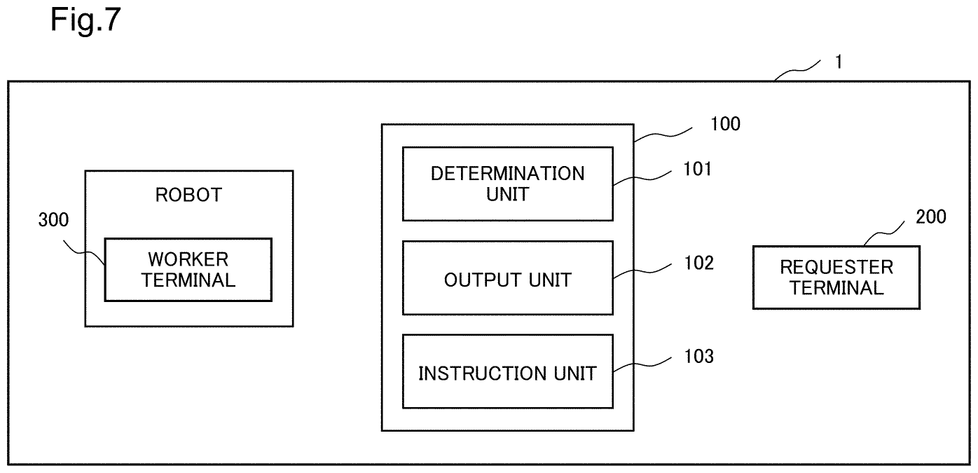

FIG. 7 is a block diagram illustrating a configuration of the pickup support system 1 according to the present modification example. In the present modification example, the pickup support device 100 may include an instruction unit 103 that instructs the robot to perform pickup at the position indicated in the pickup request as well as the components described in each of the above-described example embodiments. Regarding the modified configuration illustrated in FIG. 7, description of similar components to those of each of the above-described example embodiments will be omitted.

The robot acquires positional information of the robot by means of a global positioning system (GPS) or the like. The robot may previously store the images of the road, the appearance of the building, the interior of the building, and the like in association with the map, and compare the stored images with the image imaged by the camera to acquire the current positional information. When an aerial drone picks up a package, the drone may pick up a package placed on the balcony of the building.

Similarly to the case where the worker picks up the package, the robot transmits, to the pickup support device 100, information regarding appearance of the object X acquired from the object X at the position indicated in the pickup request. The output unit 102 of the pickup support device 100 notifies the robot of a determination result. When the robot is notified that the object X is the pickup target A, the robot picks up the object X. At the time of pickup, the robot may grip the object X with an arm or hang the object with an appropriate mechanism.

### [Modification Example] Packaging Service

The worker or the robot may bring a case such as a box that fits the pickup target to the pickup position in accordance with the stereoscopic data indicated in the pickup request. After the pickup target is identified, the worker or the robot stores the pickup target in the case. The robot may also package the pickup target with a freely deformable packaging material using the stereoscopic data of the object X at the pickup position. The robot may use, for example, a stretchable box, a sheet, or the like as the packaging material.

In a case where the packaging service as in the present modification example is employed, the pickup requester does not need to package the pickup target.

### [Modification Example] Another Application Example

The present disclosure may be used not only for pickup of a delivery item but also for collection of a trash or a recycled item. For example, the user who wants a trash to be collected images the trash using the requester terminal 200 and transmits a collection request (pickup request) to the pickup support device 100. The trash collection company transmits a collection instruction to the worker terminal 300. When it is determined by the determination unit 101 that the trash placed at the instructed location is a collection target, the worker collects the trash.

### [Hardware Configuration]

In each of the above-described example embodiments, each component of the pickup support device 100 represents a functional unit block. The functions of some or all of the components of each device (the pickup support device 100, the requester terminal 200, or the worker terminal 300) may be fulfilled by a freely-selected combination of a computer 500 and a program. The functions of the pickup support device 100 and the requester terminal 200 may be fulfilled by a single computer 500. The functions of the pickup support device 100 and the worker terminal 300 may be fulfilled by a single computer 500. In this case, the worker terminal 300 may include the components (the determination unit 101 and the output unit 102) of the pickup support device 100.

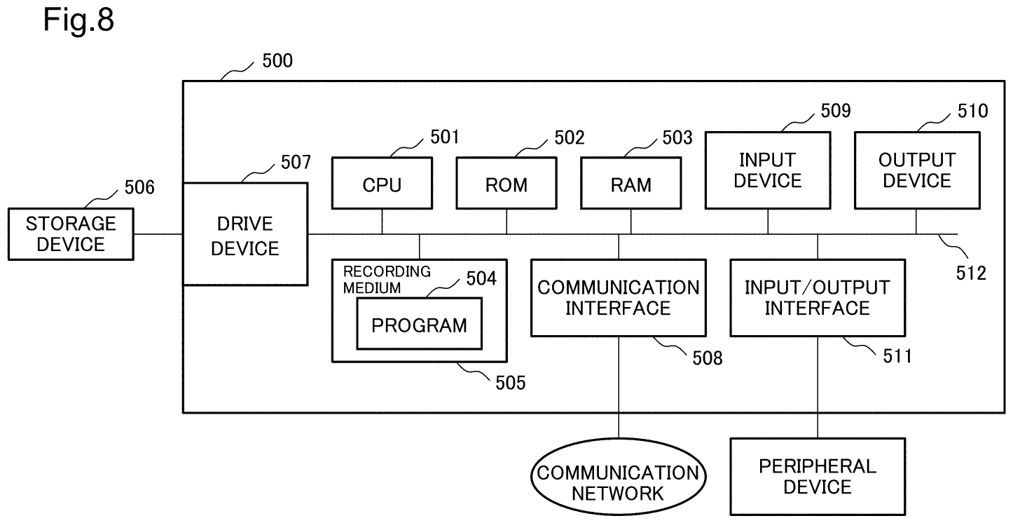

FIG. 8 is a block diagram illustrating an example of a hardware configuration of the computer 500. Referring to FIG. 8, the computer 500 includes, for example, a central processing unit (CPU) 501, a read only memory (ROM) 502, a random access memory (RAM) 503, a program 504, a storage device 505, a drive device 507, a communication interface 508, an input device 509, an input/output interface 511, and a bus 512.

The program 504 includes an instruction for fulfilling each function of each device. The program 504 is stored in advance in the ROM 502, the RAM 503, or the storage device 505. The CPU 501 fulfills each function of each device by executing the instruction included in the program 504. For example, the CPU 501 of the pickup support device 100 executes the instruction included in the program 504 to cause the function of the pickup support device 100 to be fulfilled. The RAM 503 may store data to be processed in each function of each device. For example, the pickup request of the pickup support device 100 may be stored in the RAM 503 of the computer 500.

The drive device 507 reads from and writes in the recording medium 506. The communication interface 508 provides an interface with a communication network. The input device 509 is, for example, a mouse, a keyboard, or the like, and receives an input of information from a pickup and delivery company or the like. An output device 510 is, for example, a display, and outputs (displays) information to a pickup and delivery company or the like. The input/output interface 511 provides an interface with a peripheral device. The bus 512 connects the components of the hardware with each other. The program 504 may be supplied to the CPU 501 via the communication network, or may be stored in the recording medium 506 in advance, read by the drive device 507, and supplied to the CPU 501.

Note that the hardware configuration illustrated in FIG. 8 is illustrative, and other components may be added, or some of the components do not need to be included.

There are various modification examples of the method for fulfilling the function of each device. For example, the function of each device may be fulfilled by a freely-selected combination of a computer and a program different for each component. Also, the functions of a plurality of components included in each device may be fulfilled by a freely-selected combination of a computer and a program.

Also, the functions of some or all of the components of each device may be fulfilled by general-purpose or dedicated circuitry including a processor or the like, or a combination of these. Each of the pieces of circuitry may be configured by a single chip or may be configured by a plurality of chips connected via a bus. The functions of some or all of the components of each device may be fulfilled by a combination of the above-described circuitry or the like and a program.

In a case where the functions of some or all of the components of each device are fulfilled by a plurality of computers, pieces of circuitry, and the like, the plurality of computers, the pieces of circuitry, and the like may be arranged in a centralized manner or in a distributed manner.

At least a part of the pickup support system 1 may be provided in a software as a service (SaaS) format. That is, at least some of the functions for achieving the pickup support device 100 may be executed by software executed via a network.

Although the present disclosure has been described with reference to the example embodiments, the present disclosure is not limited to the example embodiments. Various changes in form and details of the present disclosure that can be understood by those of ordinary skill in the art can be made within the scope of the present disclosure. The components in each of the example embodiments can be combined with each other without departing from the scope of the present disclosure.

Some or all of the above example embodiments can be described as the following supplementary notes, but are not limited to the following supplementary notes.

### [Supplementary Note 1]

A pickup support device according to the present disclosure includes a determination means that determines whether an object is a pickup target, based on information regarding appearance of the pickup target and information regarding appearance of the object at a position indicated in a pickup request, and an output means that outputs a determination result.

### [Supplementary Note 2]

The pickup support device according to supplementary note 1, wherein the determination means determines whether the object is the pickup target by comparing imaging data of the pickup target with imaging data of the object as the information regarding the appearances.

### [Supplementary Note 3]

The pickup support device according to supplementary note 2, wherein the imaging data of the pickup target and the imaging data of the object include a background of the pickup target and a background of the object, respectively.

### [Supplementary Note 4]

The pickup support device according to any one of supplementary notes 1 to 3, wherein the determination means determines whether the object is the pickup target by comparing a shape of the pickup target with a shape of the object as the information regarding the appearances.

### [Supplementary Note 5]

The pickup support device according to any one of supplementary notes 1 to 4, further including:
an instruction means configured to instruct a robot to perform pickup at the position when the pickup request is received,
wherein the output means notifies the robot of the determination result, and
wherein the robot transmits information regarding appearance of the object acquired at the position from the object at the position to the pickup support device, and picks up the object when the pickup support device notifies that the object is the pickup target.

### [Supplementary Note 6]

The pickup support device according to any one of supplementary notes 1 to 5, wherein, in a case where it cannot be determined based on the information regarding the appearances that the object is the pickup target, the determination means transmits the imaging data of the object to a pickup requester, and determines whether the object is the pickup target based on an input from the pickup requester.

### [Supplementary Note 7]

The pickup support device according to supplementary note 6, wherein the case where it cannot be determined that the object is the pickup target includes at least one of a case where a degree of similarity between the pickup target and the object is less than a threshold value and a case where there are a plurality of candidates for the pickup target.

### [Supplementary Note 8]

The pickup support device according to any one of supplementary notes 1 to 7, wherein, in a case where there is no candidate for the pickup target, the determination means determines that there is no pickup target at the position based on an image obtained by imaging the position.

### [Supplementary Note 9]

The pickup support device according to any one of supplementary notes 1 to 8, wherein, in a case where it cannot be determined that the object is the pickup target, or in a case where there is no object at the position, the pickup requester is notified of abort of pickup.

### [Supplementary Note 10]

A pickup support method including:
determining whether an object is a pickup target, based on information regarding appearance of the pickup target and information regarding appearance of the object at a position indicated in a pickup request; and
outputting a determination result.

### [Supplementary Note 11]

The pickup support method according to supplementary note 10, wherein it is determined whether the object is the pickup target by comparing imaging data of the pickup target with imaging data of the object as the information regarding the appearances.

### [Supplementary Note 12]

The pickup support method according to supplementary note 11, wherein the imaging data of the pickup target and the imaging data of the object include a background of the pickup target and a background of the object, respectively.

### [Supplementary Note 13]

The pickup support method according to any one of supplementary notes 10 to 12, wherein it is determined whether the object is the pickup target by comparing a shape of the pickup target with a shape of the object as the information regarding the appearances.

### [Supplementary Note 14]

The pickup support method according to any one of supplementary notes 10 to 13, further including:
instructing a robot to perform pickup at the position when the pickup request is received,
wherein information regarding appearance of the object that the robot has acquired at the position from the object at the position is received from the robot,
wherein the robot is notified of the determination result, and
wherein the robot picks up the object when the robot is notified that the object is the pickup target.

### [Supplementary Note 15]

The pickup support method according to any one of supplementary notes 10 to 14, wherein, in a case where it cannot be determined based on the information regarding the appearances that the object is the pickup target, the imaging data of the object is transmitted to a pickup requester, and it is determined whether the object is the pickup target based on an input from the pickup requester.

### [Supplementary Note 16]

A program recording medium that non-transiently records a program that causes a computer to execute:
determination processing of determining whether an object is a pickup target, based on information regarding appearance of the pickup target and information regarding appearance of the object at a position indicated in a pickup request; and
output processing of outputting a determination result.

### [Supplementary Note 17]

The program recording medium according to supplementary note 16, wherein, in the determination processing, it is determined whether the object is the pickup target by comparing imaging data of the pickup target with imaging data of the object as the information regarding the appearances.

### [Supplementary Note 18]

The program recording medium according to supplementary note 17, wherein the imaging data of the pickup target and the imaging data of the object include a background of the pickup target and a background of the object, respectively.

### [Supplementary Note 19]

The program recording medium according to any one of supplementary notes 16 to 18, wherein, in the determination processing, it is determined whether the object is the pickup target by comparing a shape of the pickup target with a shape of the object as the information regarding the appearances.

### [Supplementary Note 20]

The program recording medium according to any one of supplementary notes 16 to 19, further including:
processing of instructing a robot to perform pickup at the position when the pickup request is received; and
processing of receiving from the robot information regarding appearance of the object acquired at the position from the object at the position,
wherein, in the output processing, the robot is notified of the determination result, and
wherein the robot picks up the object when the robot is notified that the object is the pickup target.

### [Supplementary Note 21]

The program recording medium according to any one of supplementary notes 16 to 20, further including:
in a case where it cannot be determined based on the information regarding the appearances that the object is the pickup target, transmitting the imaging data of the object to a pickup requester, and determining whether the object is the pickup target based on an input from the pickup requester.

### REFERENCE SIGNS LIST

100 pickup support device
101 determination unit
102 output unit
200 requester terminal
300 worker terminal
500 computer

What is claimed is:

1. A pickup support device comprising:
at least one memory configured to store instructions; and
at least one processor configured to execute the instructions to:
determine whether an object is a pickup target, based on information regarding appearance of the pickup target and information regarding appearance of the object at a position indicated in a pickup request; and
output a determination result.

2. The pickup support device according to claim 1, wherein the at least one processor is further configured to execute the instructions to:
determine whether the object is the pickup target by comparing imaging data of the pickup target with imaging data of the object as the information regarding the appearances.

3. The pickup support device according to claim 2, wherein the imaging data of the pickup target and the imaging data of the object include a background of the pickup target and a background of the object, respectively.

4. The pickup support device according to claim 1, wherein the at least one processor is further configured to execute the instructions to:
determine whether the object is the pickup target by comparing a shape of the pickup target with a shape of the object as the information regarding the appearances.

5. The pickup support device according to claim 1, wherein the at least one processor is further configured to execute the instructions to:
instruct a robot to perform pickup at the position when the pickup request is received; and
notify the robot of the determination result,
wherein the robot transmits information regarding appearance of the object acquired at the position from the object at the position to the pickup support device, and picks up the object when the pickup support device notifies that the object is the pickup target.

6. The pickup support device according to claim 1, wherein the at least one processor is further configured to execute the instructions to:
transmit, in a case where it cannot be determined based on the information regarding the appearances that the object is the pickup target, the imaging data of the object to a pickup requester, and
determine whether the object is the pickup target based on an input from the pickup requester.

7. (canceled)

8. The pickup support device according to claim 1, wherein the at least one processor is further configured to execute the instructions to:
determine, in a case where there is no candidate for the pickup target in an image obtained by imaging the position, that there is no pickup target at the position.

9. The pickup support device according to claim 1, wherein the at least one processor is further configured to execute the instructions to:
notify a pickup requester that pickup is cancelled, in a case where it cannot be determined that the object is the pickup target, or in a case where there is no object at the position.

10. A pickup support method comprising:
determining whether an object is a pickup target, based on information regarding appearance of the pickup target and information regarding appearance of the object at a position indicated in a pickup request; and
outputting a determination result.

11. A program recording medium that non-transiently records a program that causes a computer to execute:
determination processing of determining whether an object is a pickup target, based on information regarding appearance of the pickup target and information regarding appearance of the object at a position indicated in a pickup request; and
output processing of outputting a determination result.

12. The pickup support device according to claim 6, wherein the at least one processor is further configured to execute the instructions to:
transmit the imaging data to the pickup requester when a degree of similarity between the pickup target and the object is less than a threshold value.

13. The pickup support device according to claim 6, wherein the at least one processor is further configured to execute the instructions to:
transmit the imaging data to the pickup requester when there are a plurality of candidates for the pickup target.
